(19) United States
(12) Patent Application Publication
(10) Pub. No.: US 2008/0299858 A1
(43) Pub. Date: Dec. 4, 2008

(54) STRUCTURED MULTILAYERED NON-WOVEN FABRIC

(75) Inventor: Dirk Salmon, Gilching (DE)

Correspondence Address: WOLF GREENFIELD & SACKS, P.C., 600 ATLANTIC AVENUE, BOSTON, MA, 02210-2206, US

(73) Assignee: VERMOP Salmon GmbH, Gilching (DE)

(21) Appl. No.: 12/132,331

(22) Filed: Jun. 3, 2008

(30) Foreign Application Priority Data
Jun. 4, 2007 (DE) 10 2007 026 019.0
Sep. 13, 2007 (DE) 10 2007 043 566.7

(51) Int. Cl. B32B 5/26; D04H 13/00

(52) U.S. Cl. 442/381; 28/111; 28/107

(57) ABSTRACT

Structured, multilayered non-woven fabric, having at least two types of fibrous non-woven components (1, 2) differing from one another at least in their material composition, characterised in that fibres of a first fibrous non-woven component (1) are pulled substantially vertically out of a surface of the non-woven fabric and form a first fibrous pile component (3), and fibres of the second non-woven component (2) are likewise pulled substantially vertically in a partial alignment out of the same surface and form a second fibrous pile component (4). Process for manufacturing non-woven fabrics, comprising at least two types of fibrous non-woven components (1, 2) differing from each other at least in their material composition, whereby the process includes the steps:

a) Pulling of a first fibrous pile component (1) out of a first fibrous non-woven component in order to form a first fibrous pile component (3);
b) Pulling of a second fibrous pile component (2) out of a second fibrous non-woven component in order to form a second fibrous pile component (4); whereby pulling out of the different types of fibres is performed by means of a needle punching process.

The present invention relates to a structured multilayered non-woven fabric for surface cleaning and a process for the manufacture thereof.

### PRIOR ART

Normally, non-woven fabrics for cleaning purposes consist of filament-like materials that are formed into batts by means of special textile production methods. These batts may have a pile-like surface structure with zones having different fibres and/or fibre directions. In the prior art, such zones or piles are created out of closed and/or cut filament loops. The manufacture of these structures requires a series of production steps.

A known method for production of the composite and creation of the surface uses mechanical needle punching with the assistance of special needles and a process modified, in comparison to the traditional principal of non-woven fabric interlocking, by the pulling of fibres into a moving brush bed plate. Use is known of fibrous non-woven fabrics with a continuous fibrous pile layer formed on one surface on an industrial scale as a textile floor covering in the real estate and private sector in addition to use as textile lining and laminating material in automotive construction.

DD-PS 39 819 describes a single-layer non-woven knitted fabric in which the fibres of the fibrous non-woven fabric are incorporated into a prefabricated backing web in the form of loops. The surface-structured within the meaning of the invention is achieved in this case by napping and shearing.

A product is known from DD-PS 159 353 in which fibres of nap or pile materials are pulled by means of barbed needles out of the existing pile or nap through a textile backing web and likewise form a pile layer on the rear of said backing web.

DD-PS 85141 describes the use of a backing web for creating the composite according to DD-PS 159 353, said backing web consisting of a non-woven knitted fabric interlocked without filaments by barbed needles, out of which fabric fibres may likewise contribute to the formation of a fleecy surface.

DD of 101 39 842 describes a looped part for hook and loop fasteners in which, by using a part of the mechanical finishing process on which the present invention is based on a non-woven fabric interlocked by means of fibre or filament stitches, a velvet-like surface of high density, parallelism and of even height is formed due to the pulling through of a fibrous pile layer.

DD 101 39 841 describes the production of a textile backing for carpets in which a fibrous pile layer with high density and evenness of height is formed in the same manner out of a non-woven fabric interlocked by means of fibre or filament stitches.

### PRESENTATION OF THE INVENTION

The object of the invention is to create a multilayered non-woven fabric which is particularly suitable for wet cleaning of large areas and can be produced using a simple process, and to provide a process for the manufacture thereof.

This object is achieved by the features described in claim 1. Further advantageous embodiments are described in the subclaims.

Accordingly, a structured, multilayered non-woven fabric, having at least two types of fibrous non-woven components differing from one another at least in their material composition is characterised in that fibres of a first fibrous non-woven component are pulled substantially vertically out of a surface of the non-woven fabric and form a first fibrous pile component, and fibres of the second non-woven component are likewise pulled substantially vertically out of the same surface and form a second fibrous pile component. The solution according to the invention provides a textile area for surface cleaning in which a fibrous pile layer with defined density, structure and a fibrous material composition perfectly matched to the application cases of soaking up water, picking up dirt and being capable of sliding is produced from a multilayered base material, and this fibrous layer is integrated in said base materials with a stability adequate for the intended use. It is possible to create the fibres from both of the non-woven fabrics forming the composite simultaneously and full-surface or to implement a dotted or striped pattern of the fibres pulled out of the individual components of the composite. Such a surface is suitable for the cleaning of surfaces preferably in the wet but also in the dry condition.

The first fibrous pile component is preferably formed out of dirt-absorbing fibres that have a positive effect on the sliding behaviour. In the present case of a construction with two pile structures, a first fibrous pile component may take over the dual function referred to above. It is, however, possible to incorporate more than two pile structures, the structures, sizes, fibre compositions, etc. of which are optimised in respect of the functionality to be adopted.

The second fibrous pile component is preferably formed of moisture retaining pile layer fractions. With the help of such a fibrous pile component, the non-woven fabric is especially suitable for wet cleaning of surfaces. In this case the specific design of the pile structure may, for example, be optimised in respect of the materials to be cleaned or in respect of the need to retain water.

The first fibrous non-woven component preferably forms a needle-punched non-woven fabric, which comprises a mixture of approximately 25% polyester fibres 13 dtex, approximately 50% viscose fibres 8.9 dtex and approximately 15% meltbond fibres 4.4 dtex. It has emerged that a non-woven fabric with a first non-woven component of the composition referred to above achieves the present object particularly well and can be manufactured cost-effectively.

The second fibrous non-woven component preferably forms a needle-punched non-woven fabric, which comprises a mixture of approximately 85% preferably coloured viscose fibres 1.7 dtex and approximately 15% meltbond fibres 4.4 dtex. It has emerged that a non-woven fabric with a second non-woven component of the composition referred to above achieves the present object particularly well and can be manufactured cost-effectively.

The second fibrous pile component is preferably shorter than the first fibrous pile component. The contamination and wear of the second pile structure, which is optimised to retain moisture, is reduced in this manner. Thus its functionality is retained for longer.

Preferably, the height of the first fibrous pile component ranges between 5 mm and 7 mm and of the second fibrous pile component between 3 mm and 5 mm. On the one hand the ranges meet the requirement referred to above for the second fibre component to be preferably shorter than the first, and on the other the length information provided represents a good compromise between material requirements, dirt absorption, sliding ability and moisture retention.

Preferably, arrangement of the second fibrous pile component is effected in a regular, recurring pattern. Such regularity is desirable in order to ensure a homogeneous cleaning effect of the fabric. In addition, an appropriate pattern may increase the product's recognition value and thus contribute towards combating unauthorised production and sale of copies.

The first and second fibrous non-woven components preferably have different colours. The effect of the pattern is enhanced if the fibrous non-woven components are executed in different colours.

Preferably, the fibre orientation of the fibrous non-woven component is substantially perpendicular to the fibre orientation of the fibrous pile components whereby the fibres of the pile components are still anchored with at least one end in the fibrous non-woven components. Anchoring is desirable in order to make the fabric durable and wear-resistant. The fibres remain fixed in the non-woven fabric. Consequently, the pile structures and thus the cleaning efficiency of the fabric are retained. The vertical design is advantageous so as not to impress any preferred cleaning direction on the fabric. In addition, such a non-woven fabric is easier to produce.

The object is further achieved by a process for the manufacture of non-woven fabrics, comprising at least two types of fibrous non-woven components differing from each other at least in their material composition, whereby the process includes the steps:

a) Pulling of a first fibrous pile component out of a first fibrous non-woven component in order to form a first fibrous pile component;

b) Pulling of a second fibrous pile component out of a second fibrous non-woven component in order to form a second fibrous pile component; whereby pulling out of the different types of fibres is performed by means of a needle punching process. Needles with different characteristics may be used in this connection. Such a process enables the manufacture of a non-woven fabric with the characteristics and advantages referred to above. The process is easy to carry out and low-cost. It is possible to achieve cost-effective manufacture by using this process.

Preferably, at least two needle punching machines are used back-to-back whereby the two fibrous non-woven components are pulled out one after the other. It may be advantageous, for example, to use two needle punching machines if such machines are already available due to the production of other non-woven fabrics, for example single-component non-woven fabrics. This eliminates the purchase of a needle punching machine with needle boards having two or more different needles. It may also be desirable to provide the pile formation steps of the two pile components one after the other on two needle punching machines and not simultaneously on one machine, if desired formation of the second pile component requires that the fibres of the first pile component are already correctly oriented or if formation at least benefits from such orientation.

Preferably, a single needle punching machine is used wherein the two fibrous non-woven components are pulled out at the same time. Simultaneous formation of the pile components speeds up the process and thus increases productivity.

Preferably, fork needles are used for pulling out the first fibrous non-woven component whereby the width and depth of the fork openings of the needles is approximately 0.05 mm, the penetration depth approximately 7 mm and the puncture density approximately 800 to 900 punctures per cm². An arrangement of such fork needles enables the manufacture of a first fibrous non-woven component referred to above.

Preferably, crown needles with a penetration depth of approximately 3 mm to 5 mm, preferably 4 mm, are used for pulling out the second fibrous non-woven component. An arrangement of such crown needles enables the production of a second fibrous non-woven component referred to above.

The non-woven fabric is preferably moved during the process at a feed speed of approximately 1.5 m/min to 3.5 m/min, preferably 2.5 m/min, whereby the fibres of the first fibrous non-woven component pulled out are temporarily fixed in their vertical position by a fibre holding device, a brush bed plate for example, which moves at the same feed speed. Fixing of the fibres by means of a brush bed plate enables the production of a reproducible surface with a consistent quality.

### BRIEF DESCRIPTION OF THE DRAWINGS

The invention is described in the following on the basis of embodiments. The associated drawings show FIG. 1 the schematic cross-section of the non-woven fabric structure of a first embodiment of the present invention comprising a first fibrous non-woven component through which fibres of a second fibrous non-woven component applied subsequently are pulled out in a partial plug shape onto the surface already provided with a pile layer.

FIG. 2 the schematic cross-section of the non-woven fabric structure of a further embodiment of the invention comprising of a first fibrous non-woven component and a second fibrous non-woven component out of which fibres are pulled into a joint full-surface pile layer,

FIG. 3 the schematic cross-section of the non-woven fabric structure of a further embodiment of the invention of only one non-woven component in which are comprised both a first type of fibre as well as a second type of fibre, and out of which are pulled fibre sections of all types of fibres in a full-surface pile layer of uniform height.

### WAYS OF EXECUTING THE INVENTION

The non-woven fabric structure according to the invention comprises, in accordance with a first embodiment, as shown in FIG. 1, of two prefabricated fibrous non-woven components which differ in respect of the fibrous materials contained therein. Fibrous non-woven component 1 forms a needle-punched non-woven fabric which has previously been produced from a mixture of preferably 25% polyester fibres 13 dtex, 50% viscose fibres 8.9 dtex and 15% meltbond fibres 4.4 dtex with a mass per unit area of 200 g/m². Fibrous non-woven component 2 is a needle-punched non-woven fabric which is produced from a mixture of 85% preferably coloured viscose fibres 1.7 dtex and 15% meltbond fibres 4.4 dtex with a mass per unit area of 200 g/m². Other fibre compositions are equally possible. The material composition is preferably chosen such that the first fibrous non-woven component is suitable for forming a first pile layer of dirt-absorbing fibres having a beneficial effect on the sliding behaviour and the second fibrous non-woven component is suitable for forming a second pile layer of moisture-retaining pile layer fractions.

A fibrous pile component 3 is formed on a surface by pulling fibres out vertically from the fibrous materials contained in fibrous non-woven component 1 by means of fork needles with a puncture depth of approximately 7.0 mm in a full-surface manner. The height of this fibrous pile layer is preferably between 5 and 7 mm. Fibres out of fibrous non-woven component 2 are pulled, partially and in plug shape by means of crown needles, from the back side of fibrous non-woven component 1 and passing through it, as partial fibrous pile component 4 with a height of 4 mm.

The arrangement of plug-shaped pile component 4 is pulled out in a regularly recurring pattern. The pattern is preferably punctiform. The effect of the pattern is enhanced if the fibrous non-woven components are executed in different colours. Thus a high recognition value of the product may be generated by the differing colours of fibrous non-woven fabric component 1, grey for example, and fibrous non-woven fabric component 2, yellow for example.

The process used to create a fibrous pile layer by pulling fibres out of a fibrous non-woven fabric is described as velouring. A plurality of needles penetrates the fibrous non-woven fabric vertically in order to do this. Depending on the design, either needles with a round cross-section, provided at the tip with a groove referred to as a fork, or needles with a triangular or tetragonal cross-section are equipped a short distance from the needle tip with crown-shaped barbed grooves introduced into all or selected edges. The size of the fork opening or of the grooves is chosen depending on the diameter of the fibres used in the needle-punched non-woven fabric. This ensures that fibres located in the plane of the fibrous non-woven fabric are gathered by the forks or barbs of the puncturing needles, pulled out of the non-woven fabric and pile components 3 and 4 respectively are formed projecting perpendicularly to the non-woven fabric. At the same time, the height of this pulling out movement is chosen such that the fibres remain anchored in the fibrous non-woven fabric with at least one end.

In the case of the structure shown in FIG. 1, a two-stage process is applied using two needle punching machines arranged back-to-back. In the first process step, fibrous pile component 3 is pulled out of fibrous non-woven component 1. Preferably fork needles of gauge 42 gg are used for this, the fork opening of which at a width of approx. 0.05 mm and a depth of approx. 0.05 mm is matched to the fibres of non-woven fabric 1. The penetration depth is approx. 7 mm and produces the height of fibrous pile layer 3 at approx. 5 mm. The puncturing needles with a puncture density of 800 to 900 punctures per cm² bring about a high and dense pulling out of fibres into the pile layer. Whilst the needles are executing their reverse movement, it is advantageous if the fibres pulled out are temporarily fixed in their vertical position in a brush bed plate which moves with the material at the same feed speed of preferably 2.50 m/min.

Following the first process step, fibrous non-woven component 2 is placed on the non-veloured rear side of fibrous non-woven component 1 whereby pile layer 3 remains fixed in the brush bed plate during the entire process. A second needle punching machine now pulls fibrous pile component 4 out of fibrous non-woven fabric 2 using what are known as crown needles with a penetration depth of 4 mm. The points thereof are able to make their way through already interlocked fibrous non-woven component 1 and transport the fine fibres through component 1 with the barbs mounted approx. 3 mm from the point on each of the three edges of the working part of the needle, and to form fibrous pile component 4 with a height of 3 to 5 mm on the exterior already provided with fibrous pile component 3. The crown needle must protrude out of the opposing surface of non-woven fabric 1 matching the desired pile height in order to realise a fibre pile height of 3 to 5 mm. Plug-shaped and partial formation of fibrous pile component 4 is achieved by means of a special arrangement of the needling and of the ratio between material feed and needle stroke frequency in the needle punching machine used for the second process step. A punctiform pattern is generated. Striped, grid-like or other patterns are, however, also possible.

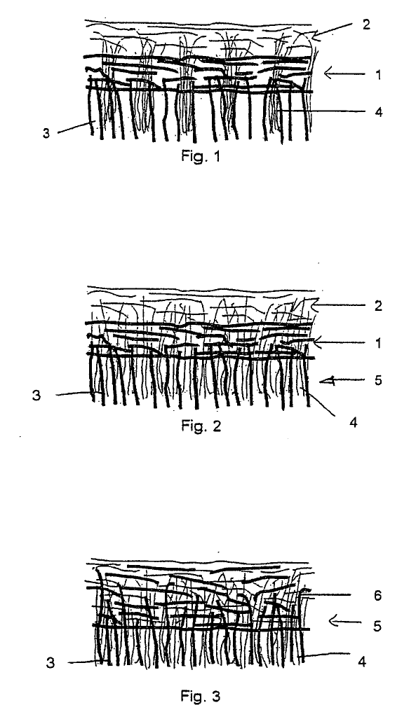

According to a further embodiment, a structure is illustrated in FIG. 2 for the creation of which both fibrous non-woven components 1 and 2 are simultaneously fed into the needle punching machine forming the fibre piles. Fibres from both fibrous non-woven components are pulled out simultaneously into fibrous pile layer 5. The gauge of the needles used must be matched to the changed conditions in respect of the different fibre diameters comprised in the material. If crown needles with a gauge of approx. 36 gg are used, mainly coarse polyester fibres and few fine viscose fibres will be pulled into the fibrous pile layer. As a result this will ensure that the finished textile structure is able to slide in the wet condition envisaged.

According to a further embodiment, FIG. 3 shows a simple embodiment example, in which all fibre materials originally comprised in fibrous non-woven components 1 and 2 are jointly comprised in comparable proportions in a fibrous non-woven fabric 6 with corresponding mass per unit area. In this case both fibrous non-woven components penetrate each other. Here too, only one needle punching machine is necessary for formation of the pile layers. By using the crown needles described in FIG. 2, it is possible to selectively pull out a larger proportion of coarse polyester fibres than of finer viscose fibres to form the sliding layer. The pile height is preferably 5 mm.

It is expressly pointed out that the processes described above may also be used on non-woven fabrics with more than two non-woven components in order to produce non-woven fabrics with three or more pile components for example. The various fibre characteristics and pile structures may at the same time fulfil different functions as is described in detail above for the case having two components.

1. Structured, multilayered non-woven fabric comprising at least two types of fibrous non-woven components differing from each other at least in their material composition, characterised in that wherein:
fibres of a first fibrous non-woven component are pulled substantially vertically out of a surface of the non-woven fabric and form a first fibrous pile component, and
fibres of the second non-woven component are likewise pulled substantially vertically out of the same surface and form a second fibrous pile component.

2. Non-woven fabric according to claim 1, characterised in that wherein the first fibrous pile component is formed out of dirt-absorbing fibres that have a positive effect on the sliding behaviour.

3. Non-woven fabric according to claim 1, wherein the second fibrous pile component is formed out of moisture-retaining pile layer fractions.

4. Non-woven fabric according to claim 1, wherein the first fibrous non-woven component forms a needle-punched non-woven fabric comprising a mixture of approximately 25% polyester fibres 13 dtex, approximately 50% viscose fibres 8.9 dtex and approximately 15% meltbond fibres 4.4 dtex.

5. Non-woven fabric according to claim 1, wherein the second fibrous non-woven component forms a needle-punched non-woven fabric comprising a mixture of approximately 85% preferably coloured polyester fibres 1.7 dtex and approximately 15% meltbond fibres 4.4 dtex.

6. Non-woven fabric according to claim 1, wherein the second fibrous pile component is shorter than the first fibrous pile component.

7. Non-woven fabric according to claim 1, wherein the height of the first fibrous pile component is in the range between 5 mm and 7 mm and the second fibrous pile component (4) is in the range between 3 mm and 5 mm.

8. Non-woven fabric according to claim 1, wherein the arrangement of the second fibrous pile component takes place in a regular, recurring pattern.

9. Non-woven fabric according to claim 1, wherein the first and second fibrous non-woven components have different colours.

10. Non-woven fabric according to claim 1, wherein the fibre alignment of the fibrous non-woven components is substantially perpendicular to the fibre alignment of the fibrous pile components, whereby the fibres of the pile components are still anchored in the fibrous non-woven components with at least one end.

11. Process for manufacturing non-woven fabrics, comprising at least two types of fibrous non-woven components differing from each other at least in their material composition, whereby the process includes the steps:
a) Pulling of a first fibrous pile component out of a first fibrous non-woven component in order to form a first fibrous pile component;
b) Pulling of a second fibrous pile component out of a second fibrous non-woven component in order to form a second fibrous pile component; whereby
pulling out of the different types of fibres is performed by means of a needle punching process.

12. Process according to claim 11, wherein at least two needle punching machines arranged back-to-back are used and the two fibrous non-woven components are pulled out one after the other.

13. Process according to claim 11, wherein a single needle punching machine is used, whereby the two fibrous non-woven components are pulled out at the same time.

14. Process according to claim 11, wherein fork needles are used for pulling out the first fibrous non-woven component whereby the width and depth of the fork openings of the needles is approximately 0.05 mm, the penetration depth approximately 7 mm and the puncture density approximately 800 to 900 punctures per cm².

15. Process according to claim 11, wherein crown needles with a penetration depth of approximately 3 mm to 5 mm, preferably 4 mm, are used for pulling out the second fibrous non-woven component.

16. Process according to claim 11, wherein the non-woven fabric is moved during the process at a feed speed of approximately 1.5 m/min to 3.5 m/min, preferably 2.5 m/min, whereby the fibres of the first fibrous non-woven component pulled out are temporarily fixed in their vertical position by a fibre holding device, a brush bed plate for example, which moves at the same feed speed.
